(19) United States
(12) Patent Application Publication
(10) Pub. No.: US 2010/0030712 A1
(43) Pub. Date: Feb. 4, 2010

(54) Guided process/procedure and knowledge and resource scripting system, toolbox and method

(75) Inventors: Richard Passovoy, Lynnwood, WA (US); Ali Daniali, Lynnwood, WA (US); Forest Hertlein, Lynnwood, WA (US); Merritt Chapman, Lynnwood, WA (US)

Correspondence Address: ATER WYNNE LLP, 1331 NW Lovejoy St. Suite 900, PORTLAND, OR, 97209-2785, US

(73) Assignee: TransAct Communications, Inc.

(21) Appl. No.: 12/220,925

(22) Filed: Jul. 29, 2008

(51) Int. Cl. G06N 5/02; G06F 17/00

(52) U.S. Cl. 706/11; 706/59

(57) ABSTRACT

System, toolbox and method are disclosed for a computer-automated process/procedure mapping system that guides development and use of decision-making and knowledge-acquiring processes. The process mapping system comprises a decision-tree diagram with templated decisional logic blocks configured for dropping selected questions therein, a question bank that stores plural questions on a given topic, a process creation mechanism coupled between the question bank and the decisional logic blocks to produce a process diagram based on a series of questions selectively sequenced by and conditioned on future responses thereto produced by a user, the process diagram comprehending conditional response paths, and a process engine coupled with the process diagram that is configured to interpret the decisional logic blocks and their response paths and to guide a user through a sequence of selected questions and responses made thereto during a diagnostic and prescriptive use session.

### FIELD OF THE INVENTION

The invention relates generally to the field of process and resource management. More particularly, the invention relates to automated procedure, knowledge and resource management.

### BACKGROUND OF THE INVENTION

Conventional project management systems have started soliciting the assistance of business process automation (BPA) software to enable a project manager to monitor a project in all its phases automatically, especially to contain costs of the project in a rapid, ever-changing business environment. A conventional BPA software program may be also capable of assisting a manger to analyze critical paths and allocate critical resources, as a useful tool in implementing business process management for a private or public company, organization, or a government agency.

GANTT diagramming is representative of schedule-based business process management, which focuses on project management, monitoring, resource allocation, and timelines (e.g. critical path analysis). GANTT diagramming; however, teaches nothing about process development or knowledge acquisition by project managers. This shortcoming may be overcome by automating its implementation with a conventional BPA toolset that comes in the form of custom application code or a specialist BPA tool. Thus, the contemporary technology has made it possible to build automation on implementation of a business process management solution, such as GANTT diagramming.

The conventional BPA software tools have failed to solve the problems caused by the conflicting nature of an implementation of business process management and its BPA software tool. For example, automation of individual processes can be delayed because the implementation of business process management requires an architecture for all processes in the business to be mapped. Therefore, the benefits of speed development brought by BPA software tools may get lost when they are used to automate the business process management implementation. Needless to say, the conventional BPA software tools have not provided guided decision-making or knowledge-acquiring processes that can be made available to general program users, including those non-technically qualified staff in the organization.

No known system in the art of computer-assisted process automation facilitates standardized process and resource definition in a simple to use form that is highly guided, e.g. scripted, to ensure reliable process and resource definition, currency, and utility among multiple process users and across multiple process disciplines.

### BRIEF DESCRIPTION OF THE DRAWINGS

FIG. 1 is a simplified schematic block diagram that illustrates a computer-assisted process road-mapping system, in accordance with one embodiment of the present invention.

FIG. 2 illustrates an exemplary decision-tree diagram that illustrates one instance of a process, knowledge and resource management system, in accordance with one embodiment of the present invention.

FIG. 3 illustrates a user interface screen that enables a remote process manager or author to organize, edit and manage the decision-tree diagram of FIG. 2 in defining process steps, preferences, and allocating needed resources.

FIG. 4 illustrates a user interface screen that enables a process manager or author to run the customized decision-tree diagram, as being part of the system of FIG. 3, in accordance with one embodiment of the present invention.

FIG. 5 illustrates an alternative user interface screen that enables a process manager or author to run the customized decision-tree diagram, as being part of the system of FIG. 3, in accordance with an alternative embodiment of the present invention.

FIG. 6 illustrates a user interface screen that enables a process manager or author to edit the customized decision-tree diagram, as being part of the system of FIG. 3, in accordance with one embodiment of the present invention.

FIG. 7 illustrates a user interface screen that enables a process manager or author to view and further develop the customized decision-tree diagram, as being part of the system of FIG. 3, in accordance with one embodiment of the present invention.

FIG. 8 illustrates a user interface screen that enables a process manager or author to add new questions to the customized decision-tree diagram, as being part of the system of FIG. 7, in accordance with one embodiment of the present invention.

### DETAILED DESCRIPTION OF THE PREFERRED EMBODIMENTS

ActPoint™ is a trademark owned by TransAct Communications, Inc.

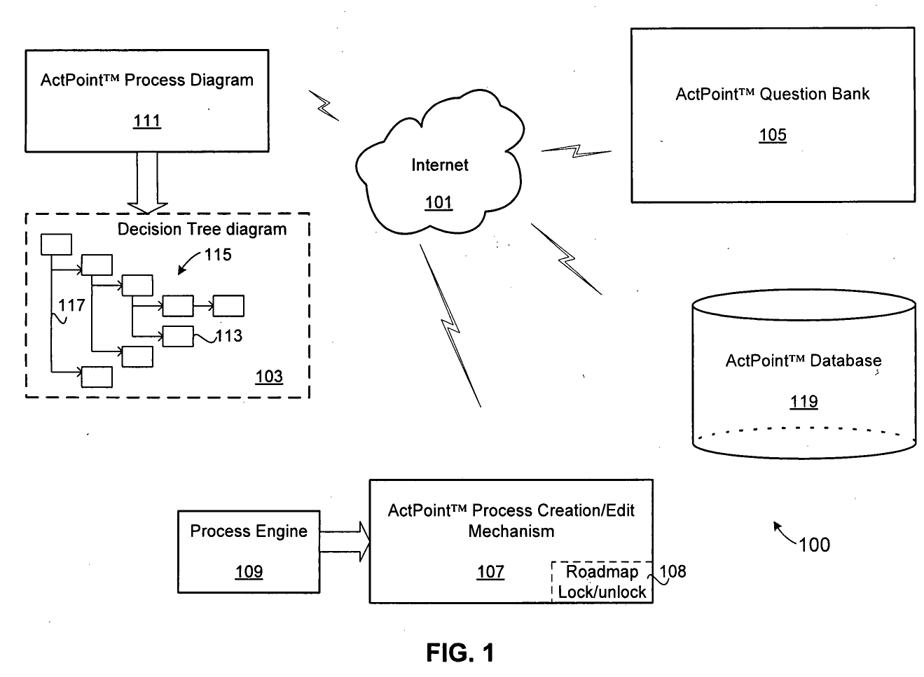

The ActPoint™ computer-assisted process mapping system is generally illustrated in FIG. 1, which is simplified to avoid obscuring an understanding of the embodiments with excess detail and where persons of ordinary skill in this art can readily understand its structure and functionality by way of the drawings and disclosure.

In accordance with an embodiment of the present invention, with reference to FIG. 1, an ActPoint™ computer-assisted process mapping system 100 operates an Internet-based network 101 to enable remote process managers or authors to produce a process diagram 115 during a definition or authoring session. A process manager or author may be understood to include those who are capable of composing or compiling a process given their knowledge or expertise in a field of concerns, for example, teachers, project managers, and specialists in education, business, law, government, etc. As will be understood by those skilled in the art, system 100 enables a remote process user to produce responses to a sequence of questions and to make decisions based upon their responses to the questions therein during a run-time use session. Thus, an ActPoint™ computer-assisted process mapping system, such as system 100, bridges use and development of defined processes or procedural roadmaps that are diagnostically and prescriptively tailored to process users' individual needs.

As illustrated by FIG. 1, in accordance with one embodiment of the present invention, system 100 comprises a process diagram 111 to assist remote process managers or authors to develop decision-making or knowledge-acquiring processes, e.g., procedural roadmaps. Typically, those processes or procedural roadmaps are built with templated building blocks under the guidance of system 100. In a particular embodiment of the present invention, process diagram 111 may be graphically presented by, for example, a decision-tree diagram 115 on a video monitor 103. Typically, a decision-tree diagram 115 is graphically constructed with plural template decisional logic blocks or nodes 113. Each of the plural template decisional logic blocks 113 is configured to capture a question selected from a predefined question bank 105 therein by a process manager or author. Question bank 105 stores predefined questions pertaining to issues or problems of concern in a field in which the process developers or authors of those questions are qualified as experts. As understood by those skilled in the art, question bank 105 is a database that may be a CD-ROM, a flash memory, a local hard drive, or a remote data storage, where the content of question bank 105 is accessible or retrievable by a remote user using a computer or a handheld device. In one embodiment of the present invention, question bank 105 may be operable to function as an independent database that is a component of an ActPoint™ system 100. In another embodiment, question bank 105 may be configured to be part of a remote server or a data warehouse, such as ActPoint™ database 119. Whichever is true, those predefined questions stored in question bank 105 are retrievable, typically through an Internet-based network 101 using any suitable LAN or WAN technologies or protocols.

Other than predefined questions stored in question bank 105, database 119 may also function as an information resource center for system 100, where templated documents, notes, and web links can be categorically stored and subsequently retrieved during a run-time definition session. System 100 makes those templated documents, notes, and web links stored in database 119 readily accessible to the remote process managers and authors as building blocks when authoring a procedure. For example, a templated note may contain information about a statutory or regulatory requirement applicable to a step or decisional logic block 113 of a procedure of preference. Moreover, a templated note may be simultaneously applicable to related but separate procedures of preferences. When one or more process managers or authors develop their procedures of preferences, each of them is enabled to copy and paste a same note or different notes from a note bank in database 119.

As disclosed above, a sequence of questions stored in question bank 105 are predefined by process managers or authors who are knowledgeable or authoritative in the field. At an early stage of definition session, those process managers or authors exercise their knowledge and expertise to accurately assess a problem or issues of concerns and define appropriate actions, e.g., procedural steps, under the guidance of an ActPoint™ system 100. Based on such issue assessment, each question developed by those process manager or authors is diagnostic and prescriptive in its nature, and each sequence of such diagnostic questions is developed and constructed to accomplish a particular goal, such as compliance with requirements of policies, operating procedures, statutes and regulations. A well defined question set therefore becomes a useful tool to guide remote process users' knowledge-acquiring and/or decision-making procedures on a topic of preference.

Again referencing to FIG. 1, system 100 is characterized by a process creation/edit mechanism 107 that is coupled between question bank 105 and process diagram 111. Process creation mechanism/edit 107 enables a remote process manager or author to populate decisional logic blocks 113 with corresponding questions selected from question bank 105. Thus, the concept of graphic process creation is realized by ActPoint™ products, e.g., system 100, wherein the graphically represented and logically linked decision-making or knowledge-acquiring steps are performed to implement such procedures.

Process creation/edit mechanism 107 includes a copy-and-paste mechanism that enables the remote process manager or author, after selecting a particular predefined question from question bank 105, to drag and drop the selected question into one of the decisional logic blocks 113 in a process diagram such as decision tree diagram 115. As may be understood by those skilled in the art, the drag and drop mechanism implements delivery of a sequence of SQL commands that are graphically represented by decisional logic blocks 113, in accordance with certain embodiments of the present invention.

In one preferred embodiment of the present invention, process creation/edit mechanism 107 may also comprise a roadmap lock and unlock mechanism 108 that enables a group of remote process authors, e.g., members of a collaboration team, to build procedural roadmaps of their preferences using the same resources, while the system provides necessary security to the resources. For example, one of the collaboration team members may have full authoring rights during an unlock period, while the resources are locked to others.

In alternative embodiments, the resource protection and accessibility may be facilitated by a more sophisticated, yet easier-to-use, check-in and check-out mechanism. During a check-in period, all the collaboration team members may have full authoring rights to the data resources simultaneously, and each of their products will be separately updated and saved to their private resources. A subsequent consolidation of updated procedures in those private resources may be commanded and implemented at a higher level by a BPA program, when necessary.

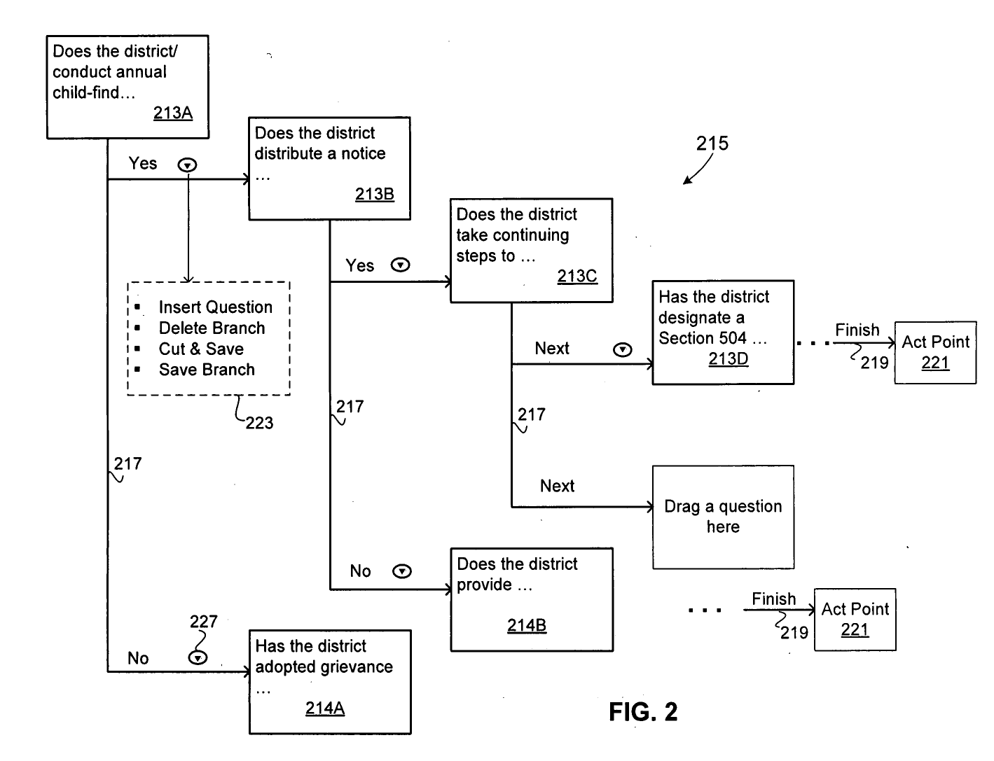

Those skilled in the art may recognize that a process diagram may comprise any of a number of forms, charts, and diagrams. In one embodiment, with reference to FIG. 1, a decision tree diagram 115 is produced and developed when the plural decisional logic blocks 113 are populated with a series of selected questions, by way of dragging and dropping those selected questions into the blocks, one at a time. Further, the plural decisional logic blocks 113 are interconnected by default decision logic paths 117, as graphically represented by decision tree diagram 115/215 (FIG. 2). The plural decisional logic blocks 113 and the default decisional paths 117 thereby create a process branch that may stand alone as an individual procedure or a step thereof or become a building block of a larger scaled decision-making or knowledge-acquiring process roadmap. The content or information contained in the process branch is based on selected questions defined and sequenced by a process manager or author, as well as conditioned on prospective responses thereto produced by a remote process user.

When populating a decisional logic block 113, in accordance with one particular embodiment with reference to FIGS. 1 and 2, a question selected from question bank 105 may be presented with yes or no response to the question. In a run-time use session of a developed procedure, a specific response from a process user, e.g., yes or no, true or false, to the question presented in on decisional logic block 113 will lead the process user through a particular path 117 to a set of subsequent predefined questions that populate the remaining decisional logic blocks 113 in the procedure. In alternative embodiments, a selected question may be presented with one or more of the following options: multiple choices, a moving-forward Next, calculated fields, and jump-point questions. Typically, a jump-point question at one ActPoint™ endpoint activates an external procedure, such as an enterprise resource planning (ERP) system, that would enable alternative user interface activities during a run-time session. In addition, the process data captured in an external procedure, the external procedure itself, and the ActPoint™ prescriptive report become electronically transferable to an external data warehouse. Thus, data duplication may be avoided under the guidance of system 100.

As will be understood by those skilled in the art, this response-based “jump” characteristic provides system optimization to ActPoint™ system 100, by way of making available to process users other external business solution applications programs that have a common database and a modular software design. Such linked external procedures include filling out an application form or entering a different application. For example, an external procedure such as filling out a form appears on a process user's screen in response to a typical “jump” question. The form is completed electronically, then the data from the form, a copy of the form itself, and the prescriptive report from ActPoint™ are electronically captured in an application, such as Microsoft® SharePoint, for clerical review. This procedure automates and streamlines a complex process approval process with no human intervention.

Each response from a prospective process user to questions presented with various user-response options determines a personal procedure of preference for the prospective process user. The personal procedure of preference guides each process user, through a particular decisional path 117, to a particular set of predefined questions presented in a plurality of decisional blocks 113, wherein the process users may identify issues, determine their knowledgebase for the issues, state their preferences, and make decisions. Characteristics of innovative ActPoint™ system 100 will be further described and disclosed in following context.

Further referencing to FIG. 1, a process engine 109 is coupled with process creation mechanism 107 to implement procedure or branch creation, thereby to interpret those decisional logic blocks 113 and their response paths 117. Process engine 109 is designated to activate and work with process creation mechanism 107, thereby to realize system 100 functionality in guiding a remote process user through a sequence of selected questions and responses made thereto during a use session. For example, a process engine 109 may facilitate the functionalities of process diagram 111, which allows process users to determine their personal procedures by assisting them in identifying their issues, available solutions, and necessary actions to be taken, based upon an information or knowledge reservoir developed by progress managers or authors.

Further referring to FIG. 1, when a decision-making process roadmap or its branch is developed, the process manager or author may save and store the process or its branches to a remote database 119. The saved and stored process or its branches are retrievable from database 119 for reuse in building a new process roadmap or a new branch of a process roadmap. Database 119 can also contain, within the spirit and scope of the invention, raw or linked knowledge data resources, e.g. articles, websites, write papers, publications, or hyperlinks representing a broad knowledge base, as will be seen. As described earlier, a database 119 acts as a broad information resource for process managers and authors, under the guidance of system 100.

In a particular embodiment of the present invention, with reference to FIG. 2, a decision tree diagram 215 that is a form of process diagram 111 of FIG. 1, may be developed by a process manager or author during a definition session. Decision tree diagram 215 may contain a plurality of decisional nodes 213/214 that are interconnected by decisional paths 217. Each of decisional nodes 213/214 is configured to capture and display a predefined question selected from question bank 105 (FIG. 1). FIG. 2 illustrates an exemplary instance of a school district compliance to a U.S. federal statutory requirement, e.g., Statute A. When defining a Statute A knowledge-acquiring procedure roadmap, process managers or authors may first exercise their knowledge or expertise in the field to assess what are the real issues associated with Statute A and, based on their assessment, to select from question bank 105 a first predefined question, for example, “Does the school district conduct an annual child-find . . . ?” Once so determined and selected, the process managers or authors may copy and paste the question intact into decisional node 213A. This drag and drop action may be completed within a very few seconds. Then, the process managers or authors may continue to exercise their knowledge or expertise in the field to determine the subsequent questions, conditioned upon a prospective response from a potential process user to the question now presented in decisional node 213A.

If a prospective response from a process user to the first question in node 213A would be a positive “yes,” the process managers or authors determine the second predefined question in question bank 105, “Does the district distribute a notice . . . ?”, would be a logic flow from the first question in node 213A. Once so determined and selected, the process managers or authors drag and drop the second question intact into decisional node 213B. Therefore, the second question in decisional node 213B and the first predefined question in decisional node 213A form a logic flow, based on a prospective positive response to the first selected question. As illustrated in FIG. 2, the logic flow is graphically represented by decisional path 217, thus to form logically linked steps of a “positive” branch to the Statute A process or procedural roadmap.

If the prospective response from the process user would be a negative “no” to the first question in node 213A, the process managers or authors determine and select from question bank 105 (FIG. 1) another predefined question that is different from the question presented in node 213B but is a logic flow from the first question presented in node 213A based on the prospective negative response thereto. Once so determined and selected, the process managers or authors can quickly and readily drag and drop the newly selected question into decisional node 214A. The determination and selection of the question in node 214A are also corresponsive to the process authors' diagnosis of the underlying issue, based on their knowledge and expertise in the field. As may be understood by those skilled in the art, decision tree diagram 215 within ActPoint™ system 100 makes it much easier and more efficient for the process managers or authors to make such determination and selection in building a procedure, i.e., a decision-making or knowledge-acquiring process roadmap. Similarly, a logic flow must also exist between the question in node 213A and the question in node 214A, thus to form a “negative” branch for the Statute A process or procedural roadmap. The logic flow for the negative branch of the Statute A process roadmap is also graphically represented by decisional paths 217.

The process managers or authors may proceed to select more predefined questions from question bank 105 and put into subsequent decisional nodes 213/214 for both positive and negative branches of the Statute A process roadmap. Among all the decisional nodes 213/214 in a roadmap branch, a logic flow must exist from one to another and is graphically represented by decisional path 217. At the end of each branch, the process managers or authors will create a conclusive end node 221, e.g., an Act Point, in which a summary of the sought knowledge about Statute A and/or suggested remedy, i.e., decision to be made, is stored and made available to remote process users. The last decisional node 213 and the ActPoint™ node 221 may be connected by a finish line 219, thus to end the logic flow for the roadmap branch and to reach a conclusion or generate a summary or report. The process definition session is highly diagnostic and prescriptive in identifying issues of preferences.

Once a decision tree diagram 215 is created on a topic of preference, it can be made available by distributing to remote process users. Those remote process users, referencing to FIG. 2 that illustrates a school district instance, may include school administrators, teachers, staff, contractors, school board members, parents and the community as a whole. Those process users can readily use decision tree diagram 215 to gain knowledge about compliance issues associated with certain requirements imposed by Statute A on school districts, or to make a decision for further action. During a use session, one or more remote process users may access the same process diagram of preference, e.g., decision tree diagram 215, view each question presented in decisional nodes 213/214 thereof, respond, and move on to subsequent questions presented in subsequent decision nodes, respectively. When a finish line 219 is reached, a process user may click on the Act Point node 221 to read the summary/report and decide what action to take in response to the information or knowledge acquired.

Further referencing FIG. 2, remote process users may decide to create personal procedures to save a particular question or question set and/or a particular knowledge branch or branches within decision tree diagram 215 for future reference. An ActPoint™ process mapping system 100 allows them to do so. After responding to a question but before going to a subsequent question in a decisional logic node 213/214, process users may click on a display-hidden icon to a pop-up window where they may select and execute the “Save a branch” option.

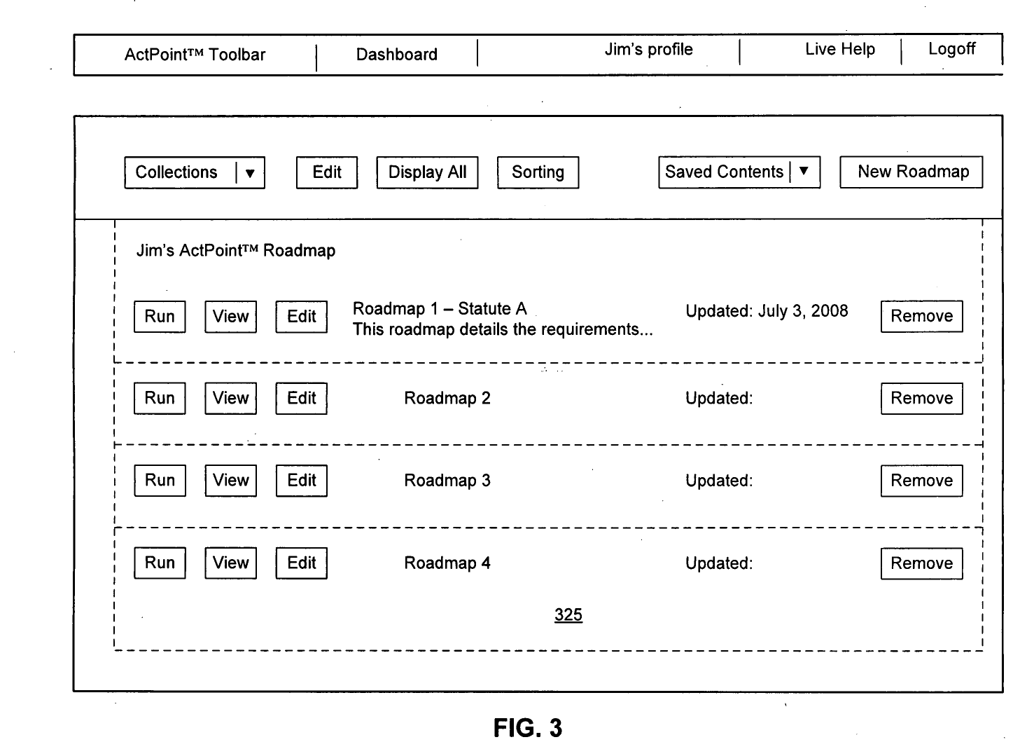

ActPoint™ system 100 provides a highly graphical and user friendly interface mechanism that enables remote process managers or authors to organize, edit and manage a process diagram 111, referring back to FIG. 1, in defining process steps, preferences, and allocating needed resources. The ActPoint™ user interface mechanisms are operable to enable remote process users to view the developed processes for making decisions or acquiring knowledge on topics of their preferences. The ActPoint™ user interface mechanisms may also enable remote process users to collect, manage and use their own personal procedures. With reference to FIG. 3, an illustrative user interface screen 325 displays a Jim's ActPoint™ roadmap, in which several procedures have been authored and developed by a process author named Jim. All the procedures, i.e., Roadmap 1, Roadmap 2, etc., are now stored in memory that is graphically represented by a Collection icon. When the Collection icon is executed, a scroll-down window appears to display all the saved and stored process roadmaps that can be developed by Jim himself or by other process authors and imported by Jim to his collection. Jim can be an expert in the field to which his roadmaps pertain, with basic computer skills, but he does not need to be a technically qualified person to author and develop procedural roadmaps of his preference.

Continuing with reference to FIG. 2, a display-hidden icon 227 appears before each predefined question except the very first question in decisional node 213A. An execution of an icon 227 activates a pop-up window 223 with several options for action. Using the pop-up window 223, Jim the process author can easily insert a question to decision tree diagram 215, delete a procedure branch, cut and save an existing question or branch, and save a new branch of his preference.

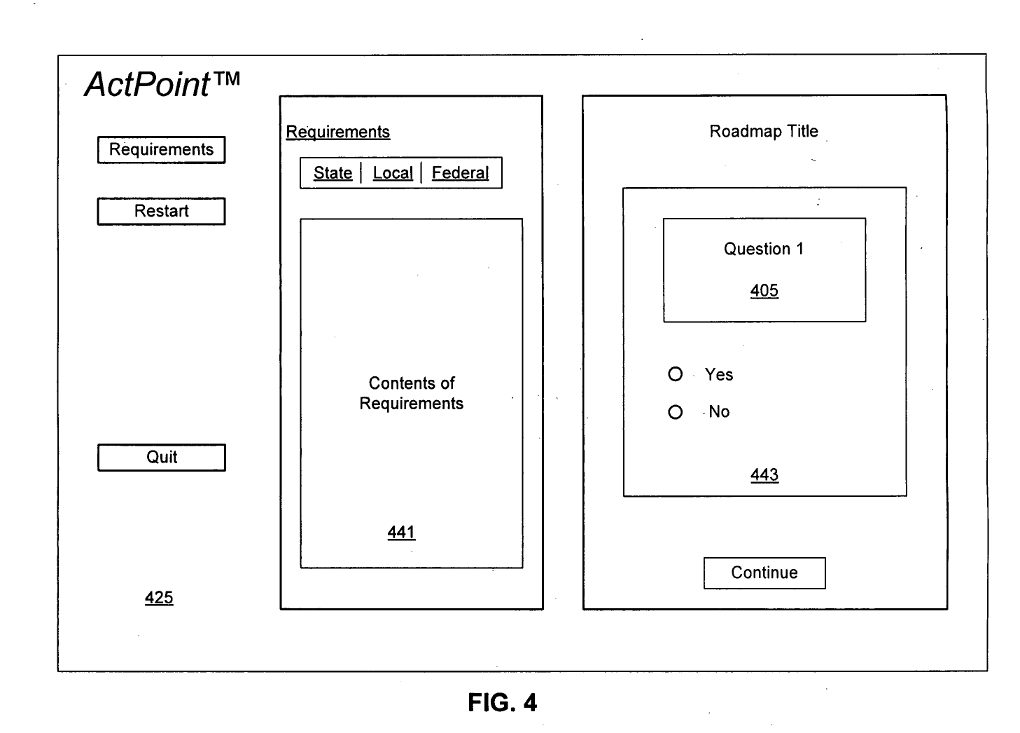

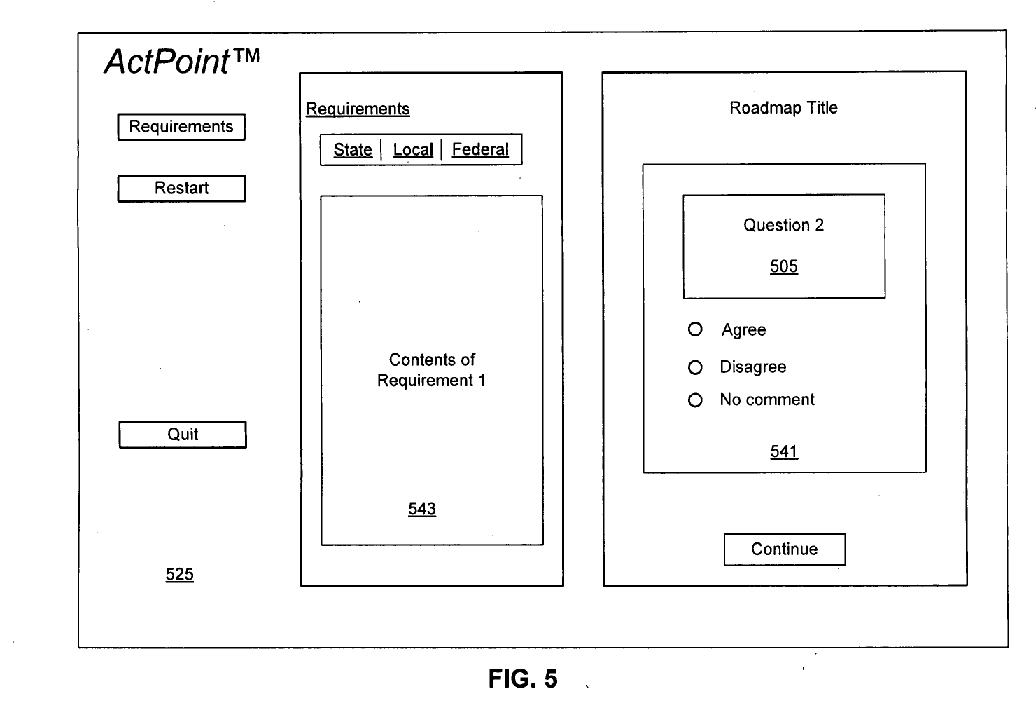

Referencing now back to FIG. 3, user interface screen 325 enables Jim to graphically select one of the options of action available to him: develop a new process roadmap of his choice, retrieve saved contents, run or edit or view a developed process roadmap stored in his collection. In an exemplary instance with reference to FIGS. 3-5, Jim decides to run a knowledge-acquiring procedural roadmap, e.g., Roadmap 1—Statute A. Both FIGS. 4 and 5 illustrate a highly graphic and user friendly ActPoint™ run mechanism integrated within system 100 (FIG. 1). In one embodiment of the present invention, with referencing to FIG. 4, a web page configured as an illustrative user interface screen 425 displays a particular question upon Jim's execution of the Run icon. Under the roadmap title, a response section 443 is configured to display the first predefined question relating to Roadmap 1 in a question section 405 and two associated response options, Yes or No. Left of response section 443, a requirements section 441 displays Requirement 1 corresponding to Question 1 presented in question section 405. After reviewing the contents of Requirement 1, Jim (now acting as a process user) is enabled to execute the yes or no response to Question 1 and the Continue option to move down the sequence of the procedure where subsequent web pages will present logically sequenced questions with corresponding requirements or resources, if any.

Continuing with referencing to FIG. 5, upon Jim's response to Question 1 as displayed in user interface screen 425 and his execution of the Continue icon, another illustrative user interface screen 525 appears where Question 2 is displayed in a question section 541 with a corresponding requirement or resource in requirements section 543 thereon. The specific Question 2 and its corresponding requirement displayed on user interface screen 525 are conditioned by Jim's positive or negative response to Question 1. Although variable because of their dependency of Jim's response, each subsequent question with or without a corresponding requirement represents a logic flow from its precedent. In the response section, a more sophisticate multiple choice may be presented with Question 2 in an alternative embodiment of the present invention. Conditioned by Jim's choice of responses, subsequent predefined questions will be displayed for view and responses in their logic relationship to the previous questions.

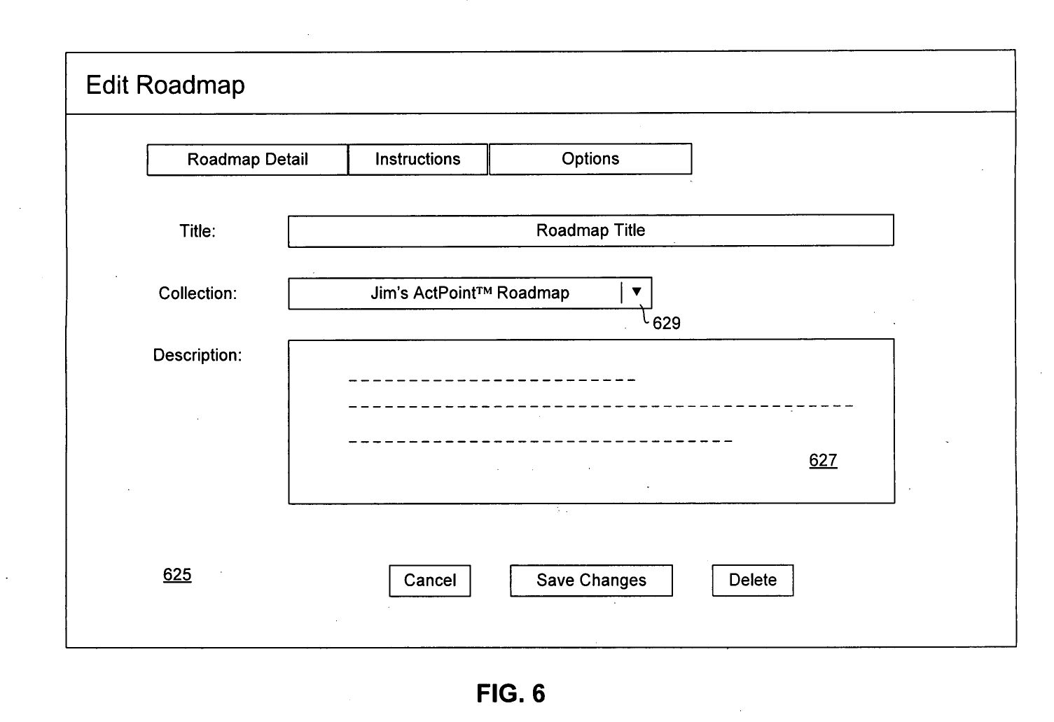

In another exemplary instance with reference to FIGS. 3 and 6, Jim decides to edit (now acts as a process author) a knowledge-acquiring process roadmap, e.g., Roadmap 1—Statute A. FIG. 6 illustrates a highly graphic and user friendly ActPoint™ edit mechanism integrated within system 100 (FIG. 1). When Jim clicks on the Edit icon, an illustrative user interface screen 625 activated by the edit mechanism will appear. In the description section 627 thereon, Jim may edit the description of the process roadmap, the questions in the process roadmap, the decision logic paths, the responses and/or their types. He may also add or delete certain decision logic nodes in a process or procedural roadmap. All the changes made by Jim during a run-time editing session can be subsequently saved and stored, modified, or rejected by executing one of the icons displayed on user interface screen 625 of FIG. 6.

During a run-time editing session, when the process editing mechanism is activated, the process diagram may be converted to a linked-list of decisional nodes in a procedure that are centrally stored in question bank 105 (FIG. 1). Those skilled in the art may understand that particular ActPoint™ process diagrams such as decision tree diagram 215 (FIG. 2) may be written in any suitable computer programming language, e.g., SQL, MySQL, or the like. The ActPoint™ process diagrams, however, are graphically presented, and can be executed syntax-free, for purpose of user-friendly process automation implementing, in a preferred embodiment of the present invention.

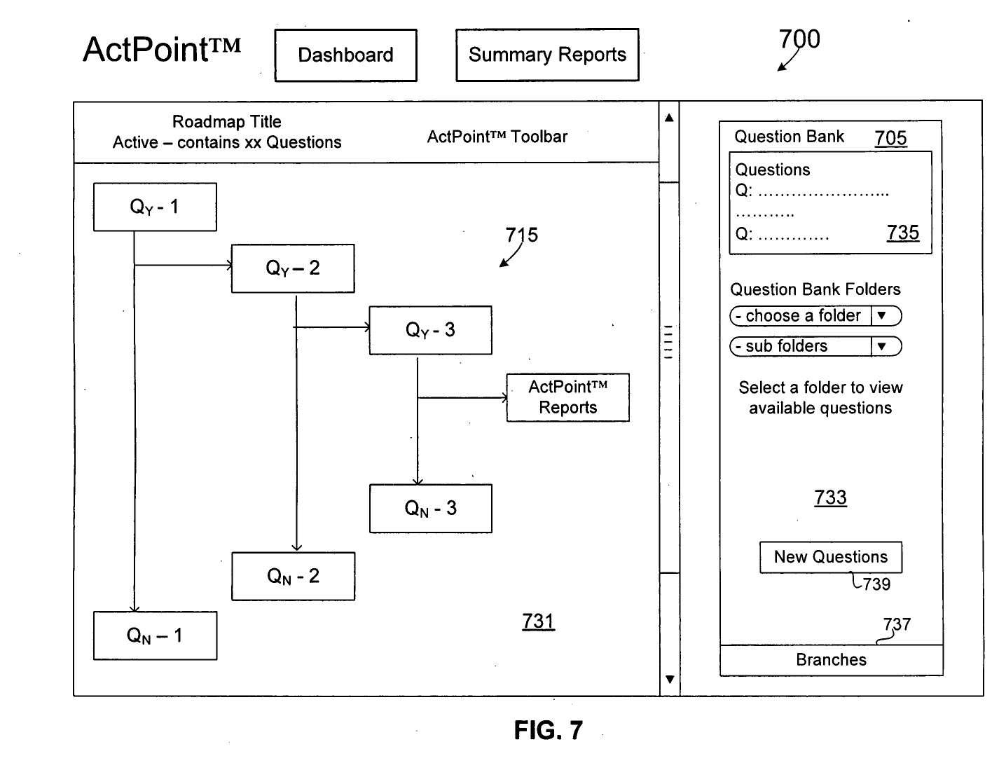

In another exemplary instance with reference to FIGS. 3 and 7, Jim decides to view (still acts as a process author) a knowledge-acquiring procedural roadmap, e.g., Roadmap 1—Statute A. FIG. 7 illustrates a highly graphical and user friendly ActPoint™ view mechanism. When Jim clicks on the View icon, an illustrative user interface screen 700 activated by the view mechanism appears. In a selection section 733 of user interface screen 700, Jim may first select a procedure of preference that is stored under a folder or sub-folder name in question bank 705. All the predefined questions for the procedure of preference will appear in a question section 735. By default, a process diagram such as decision tree diagram 715 will appear in display section 731 for Jim's view. The process diagram not only displays the predefined questions in those decision logic blocks but also illustrates the decisional paths that logically connect them. The lines and arrows graphically represent the flow of execution by a process user at run time. If Jim prefers to view a branch instead, he may go to Branch section 737 and select a branch of preference therefrom. If Jim chooses to view the summary report of the process roadmap, he may simply execute the icon on the top of user interface screen 700 to retrieve the stored report.

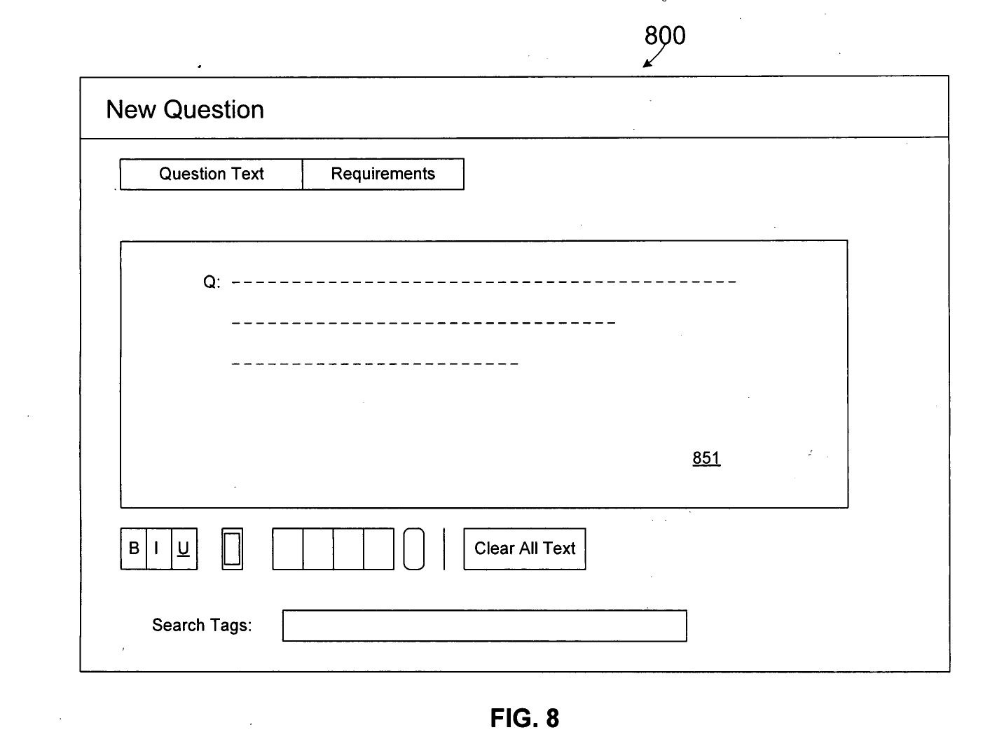

Now referencing to FIGS. 7 and 8, a New Question section 739 enables Jim to define a new question and add it to the procedure or branch of preference. A new user interface screen 800 appears when icon 739 is executed, where Jim is enabled to type in the new question text and/or its corresponding requirement in section 851 in an easy-to-use word processing environment that is similar to Windows® Word®. When the new question is defined and saved, the ActPoint™ view mechanism 700 automatically stores the new question into question bank 705 as part of the procedure of Jim's preference, e.g., a decision tree diagram 715. The new question becomes displayable in questions section 735 of FIG. 7, thereby to enable Jim to drag and drop the new question in a decision logic node within decision tree diagram 715.

As illustrated with the instance of one remote process author and user, Jim, developing and/or using a decision-making or knowledge-acquiring process are readily guided by the ActPoint™ process mapping system. Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

I claim:

1. A computer-automated guided decision-making system comprising:
a decision-tree diagram with templated decisional logic blocks configured for dropping selected questions therein;
a question bank the contents of which are plural questions that guide decision making on a given topic;
a process creation mechanism coupled between the question bank and the decisional logic blocks for populating plural logic blocks with corresponding plural questions to produce a process diagram based on a series of questions selectively sequenced by and conditioned on future responses thereto produced by a user, the process diagram comprehending conditional response paths; and
a process engine coupled with the process diagram, the process engine configured to interpret the decisional logic blocks and their response paths and to guide a user through a sequence of selected questions and responses made thereto during a use session.

2. The system of claim 1, wherein the process creation mechanism includes a drag-and-drop mechanism for selecting questions from the bank and dragging and dropping the same into the decisional logic blocks to produce the process diagram.

3. The system of claim 1, further comprising:
a network mechanism configured such that the system operates on-line to enable a remote manager to produce the process diagram during a definition session and to enable a remote user to produce responses to questions and to make decisions based upon the questions therein during a use session.

4. The system of claim 1 further comprising:
a question bank building block coupled with the question bank, the bank building block configured to enable a remote manager to script questions for a user and to store the questions in the question bank; and
an information resource center configured to enable a remote manager to store and retrieve templates of documents, data, notes and web links in a definition session.

5. The system of claim 4, wherein the question bank building block is further configured to enable a manager to edit the stored questions in the bank.

6. The system of claim 1, wherein the decisional blocks and their response paths within the populated plural logic blocks of the process diagram are configured to be copied and pasted intact into a different process diagram.

7. The system of claim 1, wherein a proper subset of the decisional blocks and their response paths within the populated plural logic blocks of the process diagram are configured to be copied and pasted intact into a different process diagram.

8. The system of claim 1, wherein each of the plural questions within the process diagram can have coupled thereto one or more resource hyperlinks to one or more contents that further explicate the decision implied by each question.

9. A computer-assisted process mapping system, comprising:
a scrollable display region of a computer monitor, the region depicting a binary decision tree diagram with predefined decisional blocks interconnected by default decisional paths, the decisional blocks configured to be populated by one or more process creators with a process script in the form of a series of questions user responses to which determine the next decisional path;
a storage mechanism for storing the created process script; and
a retrieval mechanism for retrieving an intact part or all of the stored process script and placing the same within another process script.

10. The system of claim 9, wherein the retrieval mechanism operates via a copy and paste mechanism.

11. The system of claim 9, wherein the populated decisional blocks represent predefined questions.

12. The system of claim 11, wherein one or more of the decisional paths for the predefined questions incorporate a hyperlink to an informational resource that explicates the question, thereby to guide a user through a process learning experience.

13. The system of claim 12, wherein the decisional blocks and the decisional paths are creatable by one or more process managers in a first collaborative manner.

14. The system of claim 13, wherein the first collaborative manner includes a check-in and check-out protocol for the collaboratively created process script.

15. The system of claim 14, wherein the decisional blocks and the decisional paths are editable by one or more process managers in a second collaborative manner.

16. The system of claim 15, wherein the second collaborative manner also includes a lock and unlock protocol for the collaboratively edited process script.

17. The system of claim 15, wherein the second collaborative manner also includes a check-in and check-out protocol for the collaboratively edited process script.

18. A method for creating and using a process roadmap in a network, comprising:
generating a plurality of process objects, each including a set of plural questions retrievable upon a user request;
providing a hierarchy of decisional nodes configured to correspond to the plurality of process objects, each decisional node in the hierarchy operable to guide a user to a subsequent decisional node;
designating one or more object pointers, each operable to connect a process object to a decisional block in the hierarchy responsive to the request; and
providing a process user interface coupled to the one or more object pointers, the process user interface configured to enable the user to select a question from the set and to place the selected question into one of the decisional nodes, thereby to build a decisional branch in the process roadmap.

19. The method of claim 18, in which the providing the process user interface comprises enabling the process user to drag and drop the selected question into a decisional node in the hierarchy.

20. The method of claim 19, further comprising storing one or more built decisional branches within the network.

21. The method of claim 20, in which the storing comprises sending one or more SQL commands represented by the decisional branches to a database coupled to the network.

22. The method of claim 21, further comprising retrieving the stored one or more decisional branches from the database for reuse in the process roadmap.

23. The method of claim 21, further comprising retrieving the stored one or more decisional branches from the database for reuse in another process roadmap.

24. A network-based toolbox for building a process roadmap, comprising:
a search tool configured to locate a sequence of questions predefined for the process roadmap leading to solution of a problem;
a display tool to display plural decisional blocks, each decisional block configured to capture one predefined question of the sequence;
a selecting tool configured to select one of the predefined questions from the sequence; and
an associating tool configured to associate the selected predefined question with one of the decisional blocks.

25. The toolbox in claim 24, in which the associating tool is configured to drag and drop the selected predefined question from a question bank onto the one of the decisional blocks.

26. The toolbox of claim 25, in which the plural decisional blocks are coupled to default decisional logic paths for yes or no responses to the selected predefined questions.

27. The toolbox of claim 26, in which the associating tool is configured to link one or more decisional blocks capturing one or more selected questions to create a decisional branch for the process roadmap.

28. The toolbox of claim 27, further comprising:
a storage tool configured to direct the decisional branch to a database coupled to the network.

29. The toolbox of claim 28, further comprising:
a retrieval tool configured to retrieve the stored decisional branch from the database for reuse in building another decisional branch of the process roadmap.

30. The toolbox of claim 28, further comprising:
a retrieval tool configured to retrieve the stored decisional branch from the database for reuse in building another process roadmap.

31. A method for building a computer-assisted knowledge-acquiring roadmap, comprising:
creating a sequence of predefined questions profiling a topic of concern;
providing a lattice of individual decisional nodes for capturing one or more knowledge tokens associated with the topic;
selecting a predefined question from the sequence, and placing the selected question onto one decisional node in the lattice;
connecting one or more of the placed decisional nodes with a decisional path, thereby to build a knowledge branch in the knowledge roadmap; and
graphically displaying the knowledge roadmap on a video monitor.

32. The method of claim 31, in which the selecting and placing step comprises dragging and dropping one or more questions onto one or more decisional nodes in the lattice.

33. The method of claim 32, in which the dragging and dropping comprises sending one or more SQL commands represented by the decisional nodes to a cache memory.

34. The method of claim 31, further comprising:
storing the knowledge branch of the process roadmap in a database.

35. The method of claim 34, in which the storing comprises sending one or more SQL commands represented by the decisional nodes to the database.

36. The method of claim 34, further comprising:
retrieving the knowledge branch from the database for reuse in building another knowledge branch of the process roadmap.

37. The method of claim 34, further comprising:
retrieving the knowledge branch from the database for reuse in building another process roadmap.
